(19) United States
(12) Patent Application Publication
(10) Pub. No.: US 2015/0043955 A1
(43) Pub. Date: Feb. 12, 2015

(54) IMAGE FORMING SYSTEM, IMAGE FORMING METHOD, AND COMPUTER-READABLE MEDIUM

(71) Applicant: FUJI XEROX CO., LTD., Tokyo (JP)

(72) Inventor: Mitsuyuki NISHIZAWA, Kanagawa (JP)

(73) Assignee: FUJI XEROX CO., LTD., Tokyo (JP)

(21) Appl. No.: 14/266,856

(22) Filed: May 1, 2014

(30) Foreign Application Priority Data
Aug. 8, 2013 (JP) 2013-164762

(51) Int. Cl. G03G 15/00

(52) U.S. Cl. CPC G03G 21/16
USPC 399/407

(57) ABSTRACT

An image forming system includes an image forming apparatus, multiple post-press apparatuses, a transport unit, and a recognition unit. The image forming apparatus forms an image on a recording medium. Multiple post-press apparatuses are connected to the image forming apparatus in series and perform processing on the recording medium. The transport unit transports the recording medium in the post-press apparatuses. The recognition unit recognizes an order in which the post-press apparatuses are connected, on the basis of a detection signal from a detector detecting the recording medium on a transport path of the recording medium in each of the post-press apparatuses. The detection signal is output when the transport unit transports the recording medium.

### CROSS-REFERENCE TO RELATED APPLICATIONS

This application is based on and claims priority under 35 USC 119 from Japanese Patent Application No. 2013-164762 filed Aug. 8, 2013.

### BACKGROUND

(i) Technical Field

The present invention relates to an image forming system including multiple post-press apparatuses which perform post-press processing on recording media, an image forming method, and a computer-readable medium.

(ii) Related Art

For image forming systems in which an image forming apparatus, such as a copier, a printer, or a digital multifunction device, is equipped with multiple post-press apparatuses having functions, such as folding, punching, trimming, and stapling, a technique for recognizing the order in which the post-press apparatuses are connected to the image forming apparatus has been proposed.

### SUMMARY

According to one aspect of the present invention, there is provided an image forming system including an image forming apparatus, multiple post-press apparatuses, a transport unit, and a recognition unit. The image forming apparatus forms an image on a recording medium. Multiple post-press apparatuses are connected to the image forming apparatus in series and perform processing on the recording medium. The transport unit transports the recording medium in the post-press apparatuses. The recognition unit recognizes an order in which the post-press apparatuses are connected, on the basis of a detection signal from a detector detecting the recording medium on a transport path of the recording medium in each of the post-press apparatuses. The detection signal is output when the transport unit transports the recording medium.

### BRIEF DESCRIPTION OF THE DRAWINGS

Exemplary embodiments of the present invention will be described in detail based on the following figures, wherein:

FIG. 1 is a diagram illustrating a schematic configuration of an image forming system to which a first exemplary embodiment of the present invention is applied;

FIG. 2 is a block diagram illustrating the communication connection relationship among apparatuses included in the image forming system;

FIG. 3 is a block diagram illustrating an exemplary functional configuration of a controller of a relay apparatus;

FIG. 4 is a diagram illustrating a transport path of a sheet in a group of post-press apparatuses when a transport instruction unit supplies a detour transport instruction;

FIG. 5 is a flowchart of an order-of-connection recognition process performed by a controller;

FIG. 6 is a diagram illustrating the configuration of an image forming system according to a second exemplary embodiment;

FIG. 7 is a block diagram illustrating the communication connection relationship among apparatuses included in the image forming system according to the second exemplary embodiment; and

FIG. 8 is a block diagram illustrating an exemplary functional configuration of a controller of an image forming apparatus.

### DETAILED DESCRIPTION

Referring to the attached drawings, exemplary embodiments of the present invention will be described in detail below.

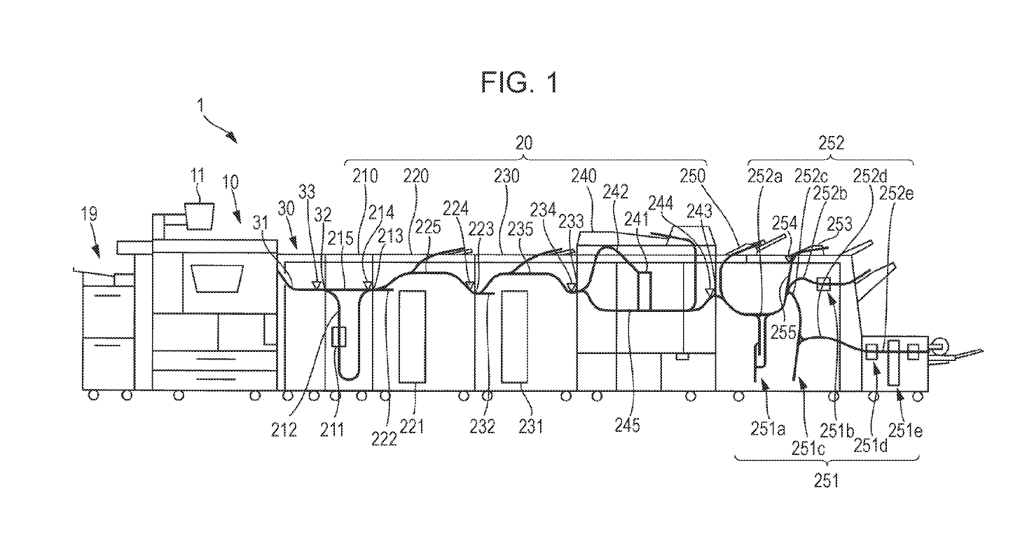

FIG. 1 is a diagram illustrating a schematic configuration of an image forming system 1 to which a first exemplary embodiment of the present invention is applied.

The image forming system 1 includes an image forming apparatus 10 which forms images on sheets of recording paper (hereinafter, simply referred to as “sheets”) which are exemplary recording media, a group of post-press apparatuses 20 which performs finishing processing on the sheets, and a relay apparatus 30 which is provided between the image forming apparatus 10 and the group of post-press apparatuses 20 and which transports the sheets discharged from the image forming apparatus 10, to the group of post-press apparatuses 20.

### Configuration of Image Forming Apparatus

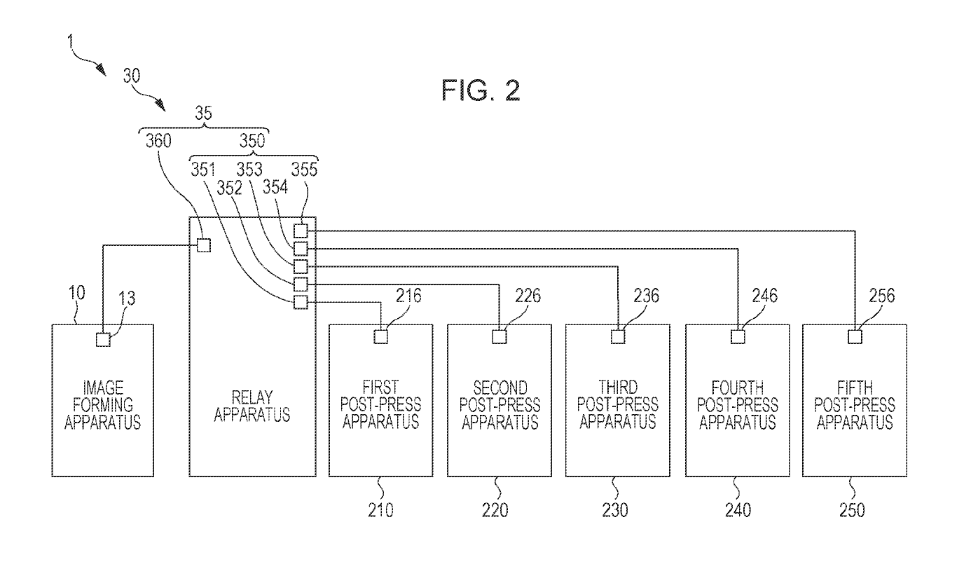

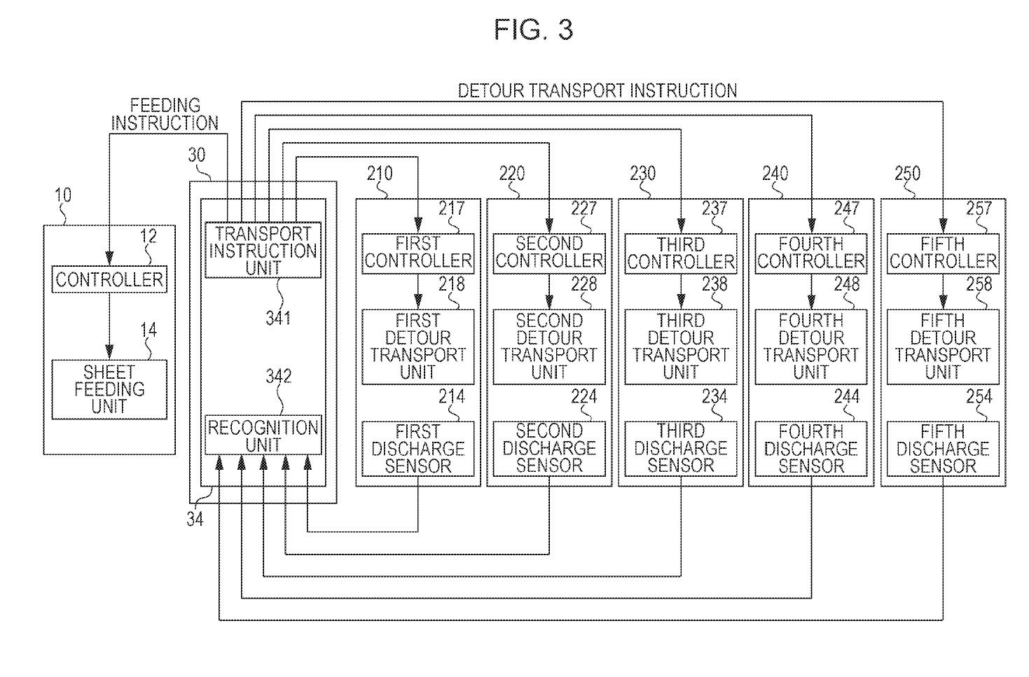

The image forming apparatus 10 is a printer or a copier which forms a color image, for example, by using an electrophotographic system, and includes an image forming unit (not illustrated) which forms an image on a sheet, an image reading unit (not illustrated) which reads out an image formed on a document, a sheet feeding unit 14 (see FIG. 3) which feeds a sheet, a user interface (UI) 11, and a controller 12 (see FIG. 3) which controls the operations of these units. The image forming apparatus 10 also includes a port 13 (see FIG. 2) to which a connector connected to an end of a communication cable which connects the image forming apparatus 10 to the relay apparatus 30 is inserted. The image forming apparatus 10 is connected to a sheet feeder 19.

The image forming unit is supplied with a sheet from the sheet feeding unit 14 or the sheet feeder 19, forms an image on the sheet, and outputs the sheet on which the image is formed, to the relay apparatus 30. The image reading unit reads out an image on a document and generates image information. The user interface 11 which presents information to a user and which receives information from a user is, for example, a liquid crystal display having a touch panel. The controller includes a central processing unit (CPU), a read-only memory (ROM), a random-access memory (RAM), and a hard disk device. The controller communicates with apparatuses on a network, such as a local area network (LAN) or the Internet, and communicates with the relay apparatus 30 via the communication cable inserted into the port 13.

### Configuration of Group of Post-Press Apparatuses

The group of post-press apparatuses 20 includes a first post-press apparatus 210, a second post-press apparatus 220, a third post-press apparatus 230, a fourth post-press apparatus 240, and a fifth post-press apparatus 250. As illustrated in FIG. 1, the first to fifth post-press apparatuses 210 to 250 are connected to the relay apparatus 30 in this order. More specifically, the first post-press apparatus 210 is directly connected to the relay apparatus 30; the second post-press apparatus 220, to the first post-press apparatus 210; the third post-press apparatus 230, to the second post-press apparatus 220; the fourth post-press apparatus 240, to the third post-press apparatus 230; and the fifth post-press apparatus 250, to the fourth post-press apparatus 240.

The first post-press apparatus 210 includes a punching processor 211 which performs punching on a sheet, a first-processing transport path 212 which is an exemplary first transport path for transporting a sheet to the punching processor 211, a first discharge unit 213 which discharges a sheet, and a first discharge sensor 214 which detects a state in which a sheet reaches the first discharge unit 213. The first post-press apparatus 210 also includes a first detour transport path 215 which is an exemplary second transport path for transporting a sheet to the first discharge unit 213 by taking a detour around the punching processor 211, instead of transporting a sheet to the punching processor 211. The first post-press apparatus 210 also includes a first-processing transport unit (not illustrated) which transports a sheet to the first-processing transport path 212, and a first detour transport unit 218 (see FIG. 3) which transports a sheet to the first detour transport path 215. The first post-press apparatus 210 also includes a first port 216 (see FIG. 2) to which a connector connected to an end of a communication cable connecting the first post-press apparatus 210 to the relay apparatus 30 is inserted, and a first controller 217 (see FIG. 3) which controls the operations of the first post-press apparatus 210 and which communicates with the relay apparatus 30 via the communication cable.

The second post-press apparatus 220 includes a loading unit 221 which loads sheets, a second-processing transport path 222 which is an exemplary first transport path for transporting a sheet to the loading unit 221, a second discharge unit 223 which discharges a sheet, and a second discharge sensor 224 which detects a state in which a sheet reaches the second discharge unit 223. The second post-press apparatus 220 also includes a second detour transport path 225 which is an exemplary second transport path for transporting a sheet to the second discharge unit 223 by taking a detour around the loading unit 221, instead of transporting a sheet to the loading unit 221. The loading unit 221 functions as a processor which performs a loading process on a large number of sheets. The second post-press apparatus 220 also includes a second-processing transport unit (not illustrated) which transports a sheet to the second-processing transport path 222, and a second detour transport unit 228 (see FIG. 3) which transports a sheet to the second detour transport path 225. The second post-press apparatus 220 also includes a second port 226 (see FIG. 2) to which a connector connected to an end of a communication cable connecting the second post-press apparatus 220 to the relay apparatus 30 is inserted, and a second controller 227 (see FIG. 3) which controls the operations of the second post-press apparatus 220 and which communicates with the relay apparatus 30 via the communication cable.

The third post-press apparatus 230 includes a loading unit 231 which loads sheets, a third-processing transport path 232 which is an exemplary first transport path for transporting a sheet to the loading unit 231, a third discharge unit 233 which discharges a sheet, and a third discharge sensor 234 which detects a state in which a sheet reaches the third discharge unit 233. The third post-press apparatus 230 also includes a third detour transport path 235 which is an exemplary second transport path for transporting a sheet to the third discharge unit 233 by taking a detour around the loading unit 231, instead of transporting a sheet to the loading unit 231. The loading unit 231 functions as a processor which performs a loading process on a large number of sheets. The third post-press apparatus 230 also includes a third-processing transport unit (not illustrated) which transports a sheet to the third-processing transport path 232, and a third detour transport unit 238 (see FIG. 3) which transports a sheet to the third detour transport path 235. The third post-press apparatus 230 also includes a third port 236 (see FIG. 2) to which a connector connected to an end of a communication cable connecting the third post-press apparatus 230 to the relay apparatus 30 is inserted, and a third controller 237 (see FIG. 3) which controls the operations of the third post-press apparatus 230 and which communicates with the relay apparatus 30 via the communication cable.

The fourth post-press apparatus 240 includes a bookbinding processor 241 which performs case binding processing on sheets, a fourth-processing transport path 242 which is an exemplary first transport path for transporting a sheet to the bookbinding processor 241, a fourth discharge unit 243 which discharges a sheet, and a fourth discharge sensor 244 which detects a state in which a sheet reaches the fourth discharge unit 243. The fourth post-press apparatus 240 also includes a fourth detour transport path 245 which is an exemplary second transport path for transporting a sheet to the fourth discharge unit 243 by taking a detour around the bookbinding processor 241, instead of transporting a sheet to the bookbinding processor 241. The fourth post-press apparatus 240 also includes a fourth-processing transport unit (not illustrated) which transports a sheet to the fourth-processing transport path 242, and a fourth detour transport unit 248 (see FIG. 3) which transports a sheet to the fourth detour transport path 245. The fourth post-press apparatus 240 also includes a fourth port 246 (see FIG. 2) to which a connector connected to an end of a communication cable connecting the fourth post-press apparatus 240 to the relay apparatus 30 is inserted, and a fourth controller 247 (see FIG. 3) which controls the operations of the fourth post-press apparatus 240 and which communicates with the relay apparatus 30 via the communication cable.

The fifth post-press apparatus 250 includes a finishing processor 251 which performs finishing processing on sheets, a fifth-processing transport path 252 which is an exemplary first transport path for transporting a sheet to the finishing processor 251, a fifth discharge unit 253 which discharges a sheet, and a fifth discharge sensor 254 which detects a state in which a sheet reaches the fifth discharge unit 253. The fifth post-press apparatus 250 also includes a fifth detour transport path 255 which is an exemplary second transport path for transporting a sheet to the fifth discharge unit 253 by taking a detour around the finishing processor 251, instead of transporting a sheet to the finishing processor 251. The fifth post-press apparatus 250 also includes a fifth-processing transport unit (not illustrated) which transports a sheet to the fifth-processing transport path 252, and a fifth detour transport unit 258 (see FIG. 3) which transports a sheet to the fifth detour transport path 255. The fifth post-press apparatus 250 also includes a fifth port 256 (see FIG. 2) to which a connector connected to an end of a communication cable connecting the fifth post-press apparatus 250 to the relay apparatus 30 is inserted, and a fifth controller 257 (see FIG. 3) which controls the operations of the fifth post-press apparatus 250 and which communicates with the relay apparatus 30 via the communication cable.

The finishing processor 251 includes a folding processor 251a which folds sheets, a binding processor 251b which makes a sheet bundle from sheets to bind the sheet bundle. The finishing processor 251 also includes a booklet unit 251c which makes a sheet bundle from sheets to create a folding book by performing saddle stitching on the sheet bundle, a corner-forming unit 251d which performs corner-forming processing in which the edge of the folded portion is pressed in order to reduce swelling of a booklet which is produced by the booklet unit 251c folding sheets into two, and a trimming unit 251e which trims a ragged portion of sheets on the trailing end of the booklet.

The fifth-processing transport path 252 includes a folding-processing transport path 252a for transporting a sheet to the folding processor 251a, a binding-processing transport path 252b for transporting a sheet to the binding processor 251b, a booklet-making transport path 252c for transporting a sheet to the booklet unit 252c, a corner-forming transport path 252d for transporting a sheet to the corner-forming unit 251d, and a trimming-processing transport path 252e for transporting a sheet to the trimming unit 251e.

The first-processing transport unit to fifth-processing transport unit and the first to fifth detour transport units 218 to 258 are constituted by multiple rollers for transporting a sheet. The first to fifth controllers 217 to 257 are apparatuses including a CPU, a ROM, and a RAM.

### Configuration of Relay Apparatus

The relay apparatus 30 includes a relay transport path 31 for transporting a sheet transported from the image forming apparatus 10, to the first post-press apparatus 210, a relay discharge unit 32 which discharges a sheet, and a relay discharge sensor 33 which detects a state in which a sheet reaches the relay discharge unit 32. The relay apparatus 30 also includes a relay transport unit (not illustrated) constituted by multiple rollers for transporting a sheet to the relay transport path 31, a controller 34 (see FIG. 3), and an interface 35 (see FIG. 2) for receiving/transmitting data from/to the group of post-press apparatuses 20 and the image forming apparatus 10.

The controller 34 is an apparatus including a CPU, a ROM, and a RAM. The specific functions of the controller 34 will be described below in detail.

FIG. 2 is a block diagram illustrating the communication connection relationship among apparatuses included in the image forming system 1.

The interface 35 includes a post-press processing port set 350 to which connectors connected to ends of communication cables connecting the relay apparatus 30 to the group of post-press apparatuses 20 are inserted, and an image-forming port 360 to which a connector connected to an end of a communication cable connecting the relay apparatus 30 to the image forming apparatus 10 is inserted. The post-press processing port set 350 according to the first exemplary embodiment is constituted by five ports, i.e., first to fifth post-press processing ports 351 to 355.

As illustrated in FIG. 2, the relay apparatus 30 according to the first exemplary embodiment is connected to the image forming apparatus 10 through a communication cable. The relay apparatus 30 is connected to each of the first to fifth post-press apparatuses 210 to 250 through a communication cable. That is, the relay apparatus 30 is connected to the first to fifth post-press apparatuses 210 to 250 in cascading connection (star connection). More specifically, as illustrated in FIG. 2, the first post-press processing port 351 of the relay apparatus 30 is connected to the first port 216 of the first post-press apparatus 210 through a communication cable. In addition, the second post-press processing port 352 of the relay apparatus 30 is connected to the second port 226 of the second post-press apparatus 220 through a communication cable; the third post-press processing port 353 of the relay apparatus 30, to the third port 236 of the third post-press apparatus 230; the fourth post-press processing port 354 of the relay apparatus 30, to the fourth port 246 of the fourth post-press apparatus 240; and the fifth post-press processing port 355 of the relay apparatus 30, to the fifth port 256 of the fifth post-press apparatus 250.

When the relay apparatus 30 is connected to each of the post-press apparatuses through a communication cable, communication is automatically performed, and the relay apparatus 30 grasps which type of post-press apparatus is connected to which port among the multiple ports included in the post-press processing port set 350. That is, the relay apparatus 30 grasps the following state. The first post-press apparatus 210 having the punching processor 211 is connected to the first post-press processing port 351; the second post-press apparatus 220 having the loading unit 221, to the second post-press processing port 352; the third post-press apparatus 230 having the loading unit 231, to the third post-press processing port 353; the fourth post-press apparatus 240 having the bookbinding processor 241, to the fourth post-press processing port 354; and the fifth post-press apparatus 250 having the finishing processor 251, to the fifth post-press processing port 355.

### Configuration of Controller of Relay Apparatus

In the image forming system 1 having the above-described configuration, the image forming apparatus 10 cooperates with the relay apparatus 30 and the group of post-press apparatuses 20 to control print processes, such as image formation on sheets, post-press processing on the sheets, and discharge of the sheets, on the basis of a print instruction from a user. At that time, the image forming apparatus 10 transmits information about a process which is to be performed by each of the first to fifth post-press apparatuses 210 to 250, via the relay apparatus 30 to the post-press apparatus on the basis of the instruction from a user.

In each of the first to fifth post-press apparatuses 210 to 250, after a sheet reaches a corresponding one of the first to fifth discharge units 213 to 253, when a corresponding one of the first to fifth discharge sensors 214 to 254 detects the sheet, the discharge sensor transmits a detection signal to the relay apparatus 30. For example, in the third post-press apparatus 230, after a sheet reaches the third discharge unit 233, when the third discharge sensor 234 detects the sheet, the third discharge sensor 234 transmits a detection signal to the relay apparatus 30.

When the relay apparatus 30 receives a detection signal from the discharge sensor (any of the first to fifth discharge sensors 214 to 254) of any of the post-press apparatuses in the group of post-press apparatuses 20, the relay apparatus 30 transmits a notification of reception of the detection signal, to the next post-press apparatus connected to the post-press apparatus that has transmitted the detection signal. In the next post-press apparatus, the controller which receives the notification (notification that the discharge sensor of the previous post-press apparatus has detected the sheet) exerts control for transporting the sheet or performing processing on the sheet. For example, when the relay apparatus 30 receives a detection signal from the fourth discharge sensor 244 of the fourth post-press apparatus 240, the relay apparatus 30 transmits a notification about this to the fifth post-press apparatus 250. In preparation for the sheet which is going to reach the fifth post-press apparatus 250, the controller of the fifth post-press apparatus 250 controls units so that the sheet is subjected to processing according to the information which has been previously received and which describes processing to be performed.

The relay apparatus 30 receives a detection signal from a discharge sensor (any of the first to fifth discharge sensors 214 to 254) in the hot line in a communication cable. Therefore, a detection signal is transmitted faster than a control signal transmitted in serial communication from the relay apparatus 30 to each of the post-press apparatuses.

In order that the first to fifth post-press apparatuses 210 to 250 operate in accordance with a request from a user, the relay apparatus 30 is to recognize the order in which the first to fifth post-press apparatuses 210 to 250 are connected. This is because, when the relay apparatus 30 receives a detection signal from the discharge sensor of any of the post-press apparatuses in the group of post-press apparatuses 20, the relay apparatus 30 needs to recognize which post-press apparatus is a post-press apparatus to which a notification about this is to be transmitted.

FIG. 3 is a block diagram illustrating an exemplary functional configuration of the controller 34 of the relay apparatus 30.

The controller 34 of the relay apparatus 30 according to the first exemplary embodiment includes a transport instruction unit 341 which is an exemplary transport unit which supplies an instruction to transport a sheet along a transport path in the group of post-press apparatuses 20, and a recognition unit 342 which is an exemplary recognition unit which recognizes the order in which the post-press apparatuses (first to fifth post-press apparatuses 210 to 250) are connected, on the basis of a detection signal which is transmitted from a discharge sensor (any of the first to fifth discharge sensors 214 to 254) that is an exemplary detector in each of the post-press apparatus and which is output when the transport instruction unit 341 transports a sheet.

The transport instruction unit 341 supplies a driving instruction to the first to fifth post-press apparatuses 210 to 250 so that a sheet is transported to the detour transport path which is an exemplary second transport path provided in each of the post-press apparatuses. In addition, the transport instruction unit 341 supplies a feeding instruction to the image forming apparatus 10 so that the image forming apparatus 10 transports a sheet to the relay apparatus 30. That is, the transport instruction unit 341 supplies, to the first to fifth post-press apparatuses 210 to 250, a detour transport instruction which is a driving instruction that the first to fifth post-press apparatuses 210 to 250 transport a sheet along the detour transport path provided in each of the post-press apparatuses. The transport instruction unit 341 also supplies the feeding instruction that the image forming apparatus 10 transport a sheet to the relay apparatus 30. The first to fifth post-press apparatuses 210 to 250 which have received the detour transport instruction drive the rollers disposed along the detour transport paths in unison so that the sheet is transported along the first to fifth detour transport paths 215 to 255 which are transport paths as a detour. The image forming apparatus 10 which has received the feeding instruction transports a sheet to the relay apparatus 30.

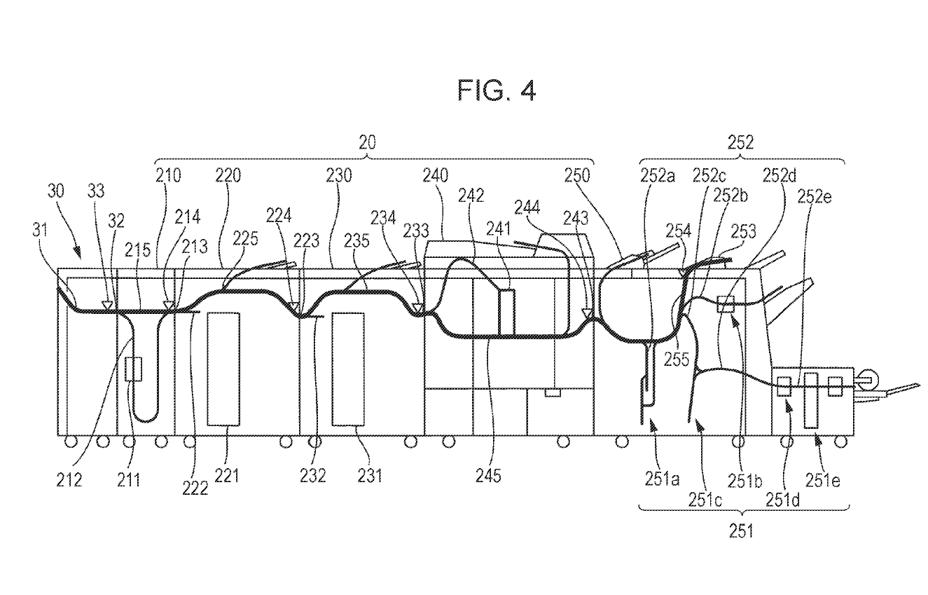

FIG. 4 is a diagram illustrating a transport path of a sheet in the group of post-press apparatuses 20 when the transport instruction unit 341 supplies a detour transport instruction.

The relay apparatus 30 transports the sheet transmitted from the image forming apparatus 10 in response to the supplied feeding instruction, to the group of post-press apparatuses 20. In the group of post-press apparatuses 20, the sheet is transported along the transport path illustrated in FIG. 4. The discharge sensors (first to fifth discharge sensors 214 to 254) provided in the first to fifth post-press apparatuses 210 to 250 output detection signals indicating detection of the sheet. The sheet passes through the first to fifth post-press apparatuses 210 to 250 in the order in which the post-press apparatuses are connected to the relay apparatus 30. Therefore, each of the discharge sensors (each of the first to fifth discharge sensors 214 to 254) outputs a detection signal in the order of connection. For example, in the image forming system 1 according to the first exemplary embodiment illustrated in FIG. 1, the first post-press apparatus 210, the second post-press apparatus 220, the third post-press apparatus 230, the fourth post-press apparatus 240, and the fifth post-press apparatus 250 are connected in this order from the relay apparatus 30 side. Therefore, when the transport instruction unit 341 supplies a detour transport instruction, detection signals are output from the first discharge sensor 214, the second discharge sensor 224, the third discharge sensor 234, the fourth discharge sensor 244, and the fifth discharge sensor 254 in this order.

The recognition unit 342 obtains a detection signal from each of the discharge sensors (first to fifth discharge sensors 214 to 254), and recognizes that the first to fifth post-press apparatuses 210 to 250 are connected in the order in which the detection signals which are output resulting from the detour transport instruction supplied by the transport instruction unit 341 are obtained. For example, as in the image forming system 1 according to the first exemplary embodiment illustrated in FIG. 1, detection signals from the first discharge sensor 214, the second discharge sensor 224, the third discharge sensor 234, the fourth discharge sensor 244, and the fifth discharge sensor 254 are output in this order. When the recognition unit 342 obtains the detection signals, the recognition unit 342 recognizes the first post-press apparatus 210, the second post-press apparatus 220, the third post-press apparatus 230, the fourth post-press apparatus 240, and the fifth post-press apparatus 250 are connected in this order. In a configuration different from that of the image forming system 1 according to the first exemplary embodiment illustrated in FIG. 1, for example, detection signals from the fourth discharge sensor 244, the second discharge sensor 224, the third discharge sensor 234, the first discharge sensor 214, and the fifth discharge sensor 254 are output in this order. When the recognition unit 342 obtains the detection signals, the recognition unit 342 recognizes that the fourth post-press apparatus 240, the second post-press apparatus 220, the third post-press apparatus 230, the first post-press apparatus 210, and the fifth post-press apparatus 250 are connected in this order.

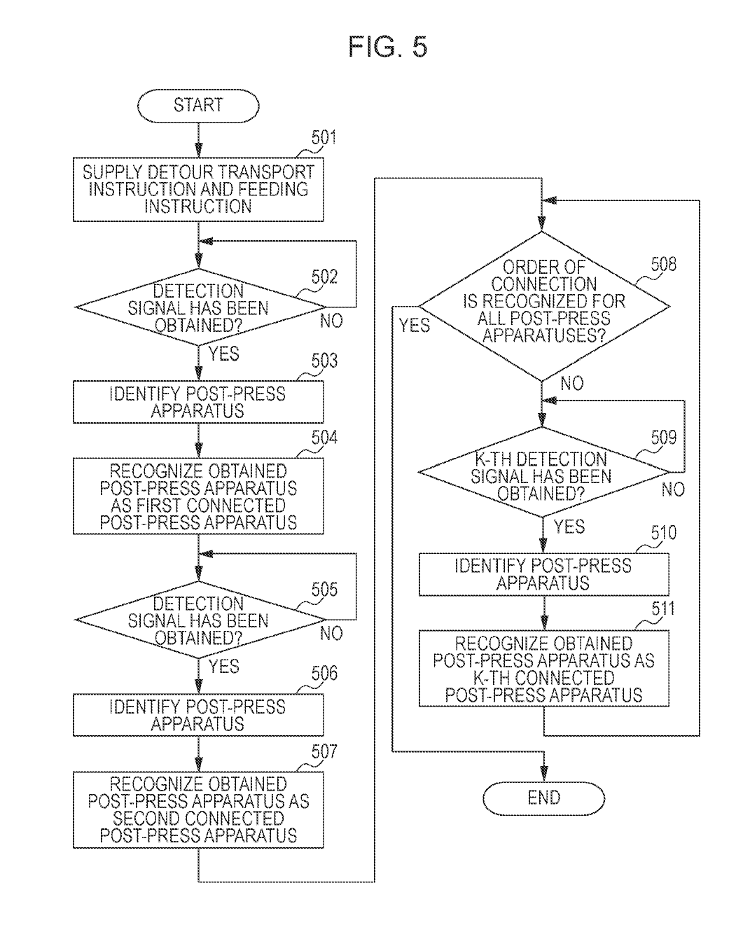

FIG. 5 is a flowchart of an order-of-connection recognition process performed by the controller 34.

The controller 34 performs the order-of-connection recognition process, for example, as a part of a startup process performed at the time of power-on.

First, the transport instruction unit 341 supplies the detour transport instruction described above to all of the connected post-press apparatuses so that a sheet is transported along the detour transport paths provided in the post-press apparatuses. In addition, the transport instruction unit 341 supplies the feeding instruction to the image forming apparatus 10 so that the image forming apparatus 10 transports a sheet to the relay apparatus 30 (in step 501). For example, in the configuration illustrated in FIG. 1, the transport instruction unit 341 supplies the detour transport instruction to the first to fifth post-press apparatuses 210 to 250 which are all post-press apparatuses connected to the relay apparatus 30, and supplies the feeding instruction to the image forming apparatus 10. Thus, in each of the post-press apparatuses, the sheet is transported along the detour transport paths.

Then, the recognition unit 342 determines whether or not a detection signal has been obtained from any of the discharge sensors (in step 502). For example, in the configuration illustrated in FIG. 1, the recognition unit 342 determines whether or not a detection signal has been obtained from any of the first to fifth discharge sensors 214 to 254. If a detection signal has been obtained (YES in step 502), the recognition unit 342 identifies which post-press apparatus is a post-press apparatus whose discharge sensor has transmitted the obtained detection signal (in step 503). That is, the recognition unit 342 grasps which port among the ports in the post-press processing port set 350 was used to obtain the detection signal, thereby grasping which post-press apparatus is a post-press apparatus from which the detection signal is obtained. After that, the recognition unit 342 recognizes the post-press apparatus obtained in step 503 as the first connected post-press apparatus (in step 504). For example, in the configuration illustrated in FIG. 1, the first detection signal is obtained through the first post-press processing port 351. Therefore, the recognition unit 342 recognizes the first post-press apparatus 210 connected to the first post-press processing port 351, as the first connected post-press apparatus. If a detection signal has not been obtained (NO in step 502), the processes in step 502 and its subsequent steps are performed again.

After the recognition unit 342 recognizes the first connected post-press apparatus in step S504, the recognition unit 342 determines whether or not a detection signal has been obtained from any of the discharge sensors (in step 505). For example, in the configuration illustrated in FIG. 1, the recognition unit 342 recognizes whether or not a detection signal subsequent to the obtained detection signal from the first discharge sensor 214 has been obtained from any of the second to fifth discharge sensors 224 to 254. If a detection signal has been obtained (YES in step 505), the recognition unit 342 identifies which post-press apparatus is a post-press apparatus whose discharge sensor has transmitted the obtained detection signal (in step 506). After that, the recognition unit 342 recognizes the post-press apparatus obtained in step 506, as the second connected post-press apparatus (in step 507). For example, in the configuration illustrated in FIG. 1, the second detection signal is obtained through the second post-press processing port 352. Therefore, the recognition unit 342 recognizes the second post-press apparatus 220 connected to the second post-press processing port 352, as the second connected post-press apparatus. If a detection signal has not been obtained (NO in step 505), the processes in step 505 and its subsequent steps are performed again.

After the recognition unit 342 recognizes the second connected post-press apparatus in step 507, the recognition unit 342 determines whether or not the order of connection is recognized for all of the post-press apparatuses connected to the relay apparatus 30 (in step 508). The recognition unit 342 has obtained the number of communication cables connected to the post-press processing port set 350. Therefore, the recognition unit 342 determines whether or not the number of data about the order of connection which has been recognized reaches the number of communication cables, thereby determining whether or not the order of connection is recognized for all of the post-press apparatuses. Alternatively, the recognition unit 342 may determine whether or not detection signals, the number of which is equal to the number of communication cables, have been obtained, thereby determining whether or not the order of connection is recognized for all of the post-press apparatuses. If the order of connection is recognized for all of the post-press apparatuses (YES in step 508), the process ends.

If the order of connection is not recognized for all of the post-press apparatuses (NO in step 508), the recognition unit 342 determines whether or not the k-th detection signal has been obtained from any of the discharge sensors (in step 509). For example, in the configuration illustrated in FIG. 1, the recognition unit 342 determines whether or not the k-th detection signal subsequent to the obtained detection signals from the first and second discharge sensors 214 and 224 has been obtained from any of the third to fifth discharge sensors 234 to 254. If the k-th detection signal has been obtained (YES in step 509), the recognition unit 342 identifies which post-press apparatus is a post-press apparatus whose discharge sensor has transmitted the obtained detection signal (in step 510). After that, the recognition unit 342 recognizes the post-press apparatus obtained in step 510, as the k-th connected post-press apparatus (in step 511). Then, the processes in step 508 and its subsequent steps are performed. That is, until the order of connection is recognized for all of the post-press apparatuses, the processes in steps 509 to 511 are repeatedly performed.

If the k-th detection signal has not been obtained (NO in step 509), the processes in step 509 and its subsequent steps are performed again.

If the order of connection is recognized for all of the post-press apparatuses (YES in step 508), the process ends.

In the example illustrated in FIG. 1, the five post-press apparatuses are connected to the relay apparatus 30. Therefore, a negative determination is made in the process in step 508 which is in the first loop after the second connected post-press apparatus is recognized in step 507, and the recognition unit 342 determines whether or not the third detection signal has been obtained from any of the discharge sensors in the process in step 509 in the first loop. If the third detection signal has been obtained (YES in step 509 in the first loop), the recognition unit 342 identifies which post-press apparatus is a post-press apparatus whose discharge sensor has transmitted the obtained detection signal (in step 510 in the first loop). After that, the recognition unit 342 recognizes the post-press apparatus obtained in step 510 in the first loop, as the third connected post-press apparatus (in step 511 in the first loop). Then, the processes in step 508 and its subsequent steps are performed again. In the configuration illustrated in FIG. 1, the third detection signal is obtained through the third post-press processing port 353. Therefore, the recognition unit 342 recognizes the third post-press apparatus 230 connected to the third post-press processing port 353, as the third connected post-press apparatus.

In the configuration illustrated in FIG. 1, the five post-press apparatuses are connected. Therefore, a negative determination is made in the process in step 508 which is in the second loop after the third connected post-press apparatus is recognized in step 511 in the first loop, and the recognition unit 342 determines whether or not the fourth detection signal has been obtained from any of the discharge sensors in the process in step 509 in the second loop. If the fourth detection signal has been obtained (YES in step 509 in the second loop), the recognition unit 342 identifies which post-press apparatus is a post-press apparatus whose discharge sensor has transmitted the obtained detection signal (in step 510 in the second loop). After that, the recognition unit 342 recognizes the post-press apparatus obtained in step 510 in the second loop, as the fourth connected post-press apparatus (in step 511 in the second loop). Then, the processes in step 508 and its subsequent steps are performed again. In the configuration illustrated in FIG. 1, the fourth detection signal is obtained through the fourth post-press processing port 354. Therefore, the recognition unit 342 recognizes the fourth post-press apparatus 240 connected to the fourth post-press processing port 354, as the fourth connected post-press apparatus.

In the configuration illustrated in FIG. 1, the five post-press apparatuses are connected. Therefore, a negative determination is made in the process in step 508 which is in the third loop after the fourth connected post-press apparatus is recognized in step 511 in the second loop, and the recognition unit 342 determines whether or not the fifth detection signal has been obtained from any of the discharge sensors in the process in step 509 in the third loop. If the fifth detection signal has been obtained (YES in step 509 in the third loop), the recognition unit 342 identifies which post-press apparatus is a post-press apparatus whose discharge sensor has transmitted the obtained detection signal (in step 510 in the third loop). After that, the recognition unit 342 recognizes the post-press apparatus obtained in step 510 in the third loop, as the fifth connected post-press apparatus (in step 511 in the third loop). Then, the processes in step 508 and its subsequent steps are performed again. In the configuration illustrated in FIG. 1, the fifth detection signal is obtained through the fifth post-press processing port 355. Therefore, the recognition unit 342 recognizes the fifth post-press apparatus 250 connected to the fifth post-press processing port 355, as the fifth connected post-press apparatus. Then, a positive determination is made in the process in step 508 in the fourth loop, and the process ends.

After the recognition unit 342 recognizes the order in which multiple post-press apparatuses (first to fifth post-press apparatuses 210 to 250) are connected, the controller 34 of the relay apparatus 30 stores the order in a storage area, and controls the operations of the post-press apparatuses on the basis of a print instruction from a user.

As described above, in the image forming system 1 according to the first exemplary embodiment, the relay apparatus 30 performs the order-of-connection recognition process, whereby the order in which multiple post-press apparatuses (first to fifth post-press apparatuses 210 to 250) are connected to the image forming apparatus 10 in cascading connection (star connection) is automatically recognized. Therefore, a user does not have to perform a manual operation of causing the image forming apparatus 10 or the relay apparatus 30 to recognize the order in which the post-press apparatuses are connected to the image forming apparatus 10. As a result, a manual process of recognizing the order is eliminated. In addition, occurrence of errors, such as a setting error and a connection error, which occur due to a setting process in which a user manually sets the order in which multiple post-press apparatuses are connected is suppressed. In the order-of-connection recognition process performed by the relay apparatus 30, a detour transport instruction is transmitted so that a sheet is transported along the detour transport paths provided in the post-press apparatuses. Therefore, recognition of the order of connection is performed more quickly than transport of a sheet along the transport paths for processing.

The relay apparatus 30 performs the order-of-connection recognition process so that the order in which multiple post-press apparatuses are connected is automatically recognized. Accordingly, it is not necessary for the use of the post-press processing port set 350 of the relay apparatus 30 to be fixed in accordance with the types of the post-press apparatuses or the order of connection of the post-press apparatuses. For example, it is not necessary to impose a restriction that the first post-press apparatus 210 having the punching processor 211 is to be connected to the first post-press processing port 351 of the relay apparatus 30. Thus, each of the ports included in the post-press processing port set 350 of the relay apparatus 30 may be connected to a communication cable for any of the post-press apparatuses. Therefore, the image forming system 1 according to the first exemplary embodiment enables time required for installation of the system to be reduced. The post-press processing port set 350 of the relay apparatus 30 may be connected to a communication cable used to establish connection with another post-press apparatus which performs a post-press process different from those of the first to fifth post-press apparatuses 210 to 250. Therefore, even when a new post-press apparatus is additionally connected to the relay apparatus 30, a new post-press processing port set 350 for the new post-press apparatus does not need to be installed, enabling the new post-press apparatus to be added without additional cost.

### Modification

In the first exemplary embodiment described above, the order-of-connection recognition process of automatically recognizing the order in which multiple post-press apparatuses (first to fifth post-press apparatuses 210 to 250) are connected is applied to the image forming system 1 having the configuration in which the relay apparatus 30 is provided between the image forming apparatus 10 and the group of post-press apparatuses 20 and in which the post-press apparatuses are connected to the relay apparatus 30 in cascading connection (star connection), but the configuration is not limited to this.

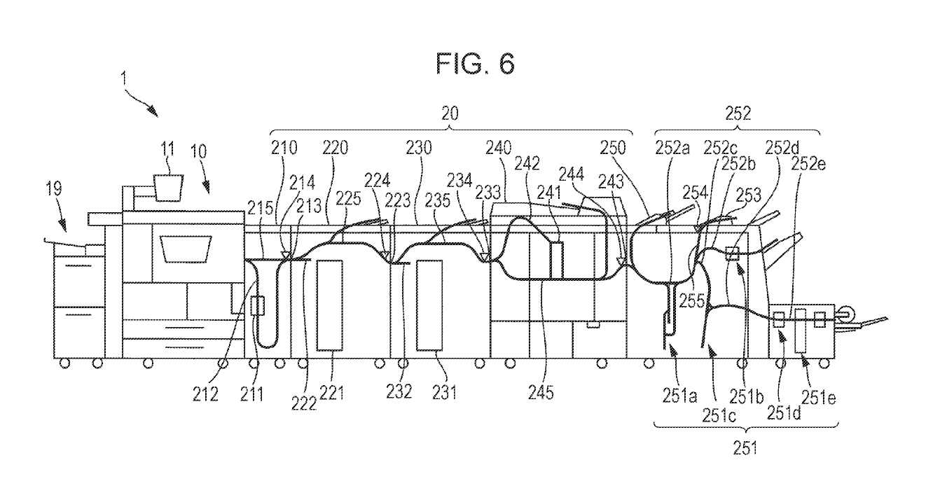

FIG. 6 is a diagram illustrating a configuration of the image forming system 1 according to a second exemplary embodiment.

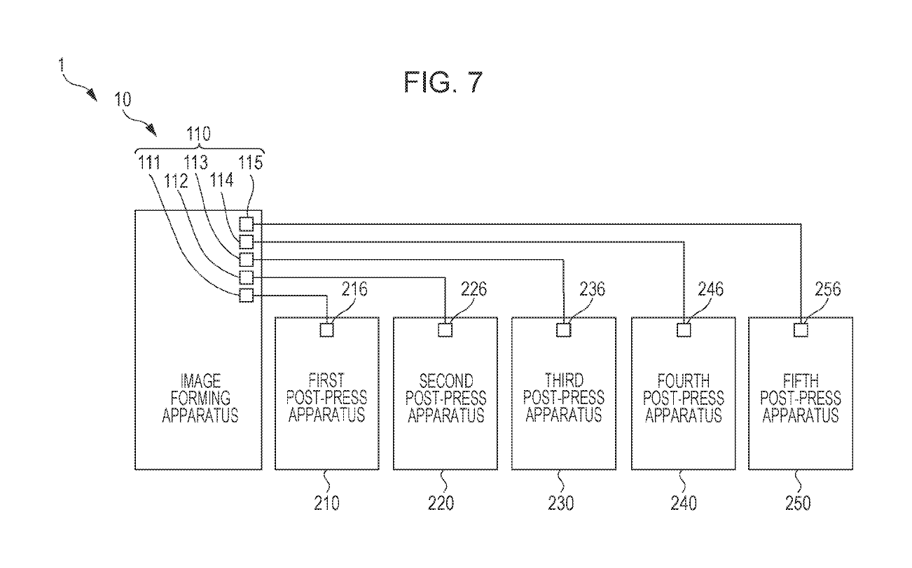

FIG. 7 is a block diagram illustrating the communication connection relationship among apparatuses included in the image forming system 1 according to the second exemplary embodiment.

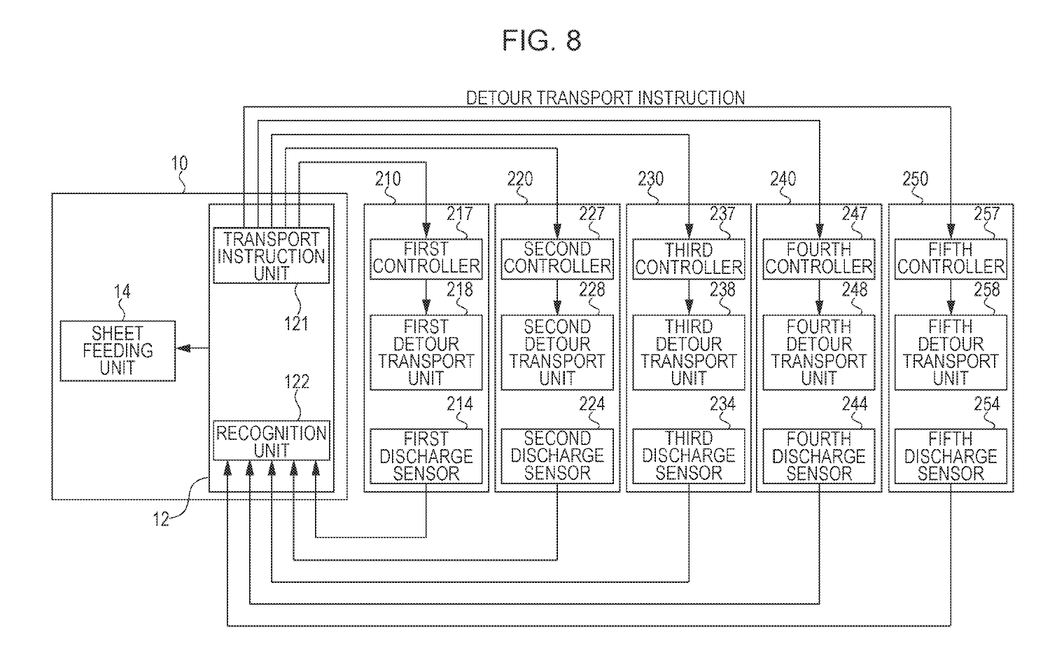

FIG. 8 is a block diagram illustrating an exemplary functional configuration of the controller 12 of the image forming apparatus 10.

The image forming system 1 according to the second exemplary embodiment is different from that in the first exemplary embodiment in that the group of post-press apparatuses 20 is directly connected to the image forming apparatus 10. The image forming apparatus 10 includes a post-press processing port set 110 (first to fifth post-press processing ports 111 to 115), and the post-press apparatuses (first to fifth post-press apparatuses 210 to 250) included in the group of post-press apparatuses 20 are connected to the image forming apparatus 10 in cascading connection (star connection).

The controller 12 of the image forming apparatus 10 may include a transport instruction unit 121 having the same function as that of the above-described transport instruction unit 341, and a recognition unit 122 having the same function as that of the above-described recognition unit 342. The transport instruction unit 121 of the controller 12 of the image forming apparatus 10 supplies a driving instruction to the first to fifth post-press apparatuses 210 to 250 so that a sheet is transported along the detour transport paths provided in the post-press apparatuses, and supplies a feeding instruction that the sheet feeding unit 14 or the sheet feeder 19 transport a sheet to the image forming apparatus 10. The recognition unit 122 of the controller 12 of the image forming apparatus 10 obtains a detection signal from each of the discharge sensors (first to fifth discharge sensors 214 to 254), and recognizes that the first to fifth post-press apparatuses 210 to 250 are connected in the order in which the detection signals which are output as a result of the detour transport instruction supplied by the transport instruction unit 121 are obtained. That is, the controller 12 of the image forming apparatus 10 performs the order-of-connection recognition process which is described by using the flowchart in FIG. 5, for example, as a part of a startup process performed at the time of power-on.

In the image forming system 1 according to the second exemplary embodiment having this configuration, the image forming apparatus 10 performs the order-of-connection recognition process, whereby the order in which multiple post-press apparatuses (first to fifth post-press apparatuses 210 to 250) are connected to the image forming system 1 in cascading connection (star connection) is automatically recognized. Therefore, a user does not have to perform a manual operation of causing the image forming apparatus 10 to recognize the order in which the post-press apparatuses are connected to the image forming apparatus 10. As a result, a manual process of recognizing the order is eliminated. In addition, occurrence of errors, such as a setting error and a connection error, which occur due to a setting process in which a user manually sets the order in which multiple post-press apparatuses are connected is suppressed.

The image forming apparatus 10 performs the order-of-connection recognition process so that the order in which multiple post-press apparatuses are connected is automatically recognized. Accordingly, it is not necessary for the use of the post-press processing port set 110 of the image forming apparatus 10 to be fixed in accordance with the types of the post-press apparatuses or the order of connection of the post-press apparatuses. For example, it is not necessary to impose a restriction that the first post-press apparatus 210 having the punching processor 211 is to be connected to the first post-press processing port 111 of the image forming apparatus 10. Thus, each of the ports included in the post-press processing port set 110 of the image forming apparatus 10 may be connected to a communication cable for any of the post-press apparatuses. Therefore, the image forming system 1 according to the second exemplary embodiment enables time required for installation of the system to be reduced. The post-press processing port set 110 of the image forming apparatus 10 may be connected to a communication cable used to establish connection with another post-press apparatus which performs a post-press process different from those of the first to fifth post-press apparatuses 210 to 250. Therefore, even when a new post-press apparatus is additionally connected to the image forming apparatus 10, a new post-press processing port set 110 for the new post-press apparatus does not need to be installed, enabling the new post-press apparatus to be added without additional cost.

The configuration of the group of post-press apparatuses 20 in the image forming system 1 described above is merely an example. The types, the number, and the order of connection of the post-press apparatuses connected to the image forming apparatus 10 or the relay apparatus 30 may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming system comprising:
an image forming apparatus that forms an image on a recording medium;
a plurality of post-press apparatuses that are connected to the image forming apparatus in series and that perform processing on the recording medium;
a transport unit that transports the recording medium in the plurality of post-press apparatuses; and
a recognition unit that recognizes an order in which the plurality of post-press apparatuses are connected, on the basis of a detection signal from a detector detecting the recording medium on a transport path of the recording medium in each of the plurality of post-press apparatuses, the detection signal being output when the transport unit transports the recording medium.

2. The image forming system according to claim 1, further comprising:
a relay apparatus that is provided between the image forming apparatus and the plurality of post-press apparatuses and that transports the recording medium discharged from the image forming apparatus, to the plurality of post-press apparatuses,
wherein the transport unit and the recognition unit are included in the image forming apparatus or the relay apparatus.

3. The image forming system according to claim 1,
wherein each of the plurality of post-press apparatuses includes at least one detector including the detector, and
wherein the recognition unit recognizes that the plurality of post-press apparatuses are connected in an order in which detection signals are obtained from the plurality of detectors included in the plurality of post-press apparatuses.

4. The image forming system according to claim 2,
wherein each of the plurality of post-press apparatuses includes at least one detector including the detector, and
wherein the recognition unit recognizes that the plurality of post-press apparatuses are connected in an order in which detection signals are obtained from the plurality of detectors included in the plurality of post-press apparatuses.

5. The image forming system according to claim 3,
wherein each of the plurality of post-press apparatuses includes
a processor that processes the recording medium discharged from the image forming apparatus,
a first transport path configured to transport the recording medium to the processor, and
a second transport path configured to discharge the recording medium from the post-press apparatus, instead of transporting the recording medium to the processor,
wherein the at least one detector is provided on a discharge side of the second transport path of each of the plurality of post-press apparatuses,
wherein the transport unit transports the recording medium to the second transport path, and
wherein the recognition unit recognizes the order in which the plurality of post-press apparatuses are connected, on the basis of at least one detection signal from the at least one detector, the at least one detection signal being output when the transport unit transports the recording medium to the second transport path.

6. The image forming system according to claim 4,
wherein each of the plurality of post-press apparatuses includes
a processor that processes the recording medium discharged from the image forming apparatus,
a first transport path configured to transport the recording medium to the processor, and
a second transport path configured to discharge the recording medium from the post-press apparatus, instead of transporting the recording medium to the processor,
wherein the at least one detector is provided on a discharge side of the second transport path of each of the plurality of post-press apparatuses,
wherein the transport unit transports the recording medium to the second transport path, and
wherein the recognition unit recognizes the order in which the plurality of post-press apparatuses are connected, on the basis of at least one detection signal from the at least one detector, the at least one detection signal being output when the transport unit transports the recording medium to the second transport path.

7. A non-transitory computer readable medium storing a program causing a computer to execute a process for image formation, the process comprising:
transporting a recording medium in a plurality of post-press apparatuses connected to an image forming apparatus in series; and
recognizing an order in which the plurality of post-press apparatuses are connected, on the basis of a detection signal from a detector detecting the recording medium on a transport path of the recording medium in each of the plurality of post-press apparatuses, the detection signal being output when the recording medium is transported.

8. The non-transitory computer readable medium according to claim 7,
wherein each of the plurality of post-press apparatuses includes at least one detector including the detector, and
wherein it is recognized that the plurality of post-press apparatuses are connected in an order in which detection signals are obtained from the plurality of detectors included in the plurality of post-press apparatuses.

9. An image forming method comprising:
transporting a recording medium in a plurality of post-press apparatuses connected to an image forming apparatus in series; and
recognizing an order in which the plurality of post-press apparatuses are connected, on the basis of a detection signal from a detector detecting the recording medium on a transport path of the recording medium in each of the plurality of post-press apparatuses, the detection signal being output when the recording medium is transported.

10. The image forming method according to claim 9,
wherein each of the plurality of post-press apparatuses includes at least one detector including the detector, and
wherein it is recognized that the plurality of post-press apparatuses are connected in an order in which detection signals are obtained from the plurality of detectors included in the plurality of post-press apparatuses.
